(19) United States
(12) Patent Application Publication
(10) Pub. No.: US 2018/0004371 A1
(43) Pub. Date: Jan. 4, 2018

(54) ELECTRONIC DEVICE AND INFORMATION PROVIDING METHOD THEREOF

(71) Applicant: Samsung Electronics Co., Ltd., Gyeonggi-do (KR)

(72) Inventors: Insil HAN, Seoul (KR); Hyunyeul LEE, Seoul (KR)

(21) Appl. No.: 15/636,977

(22) Filed: Jun. 29, 2017

(30) Foreign Application Priority Data
Jul. 1, 2016 (KR) 10-2016-0083622

(51) Int. Cl. G06F 3/0483; G06F 3/0485; G06F 9/445; G06F 3/0482

(52) U.S. Cl. CPC G06F 3/0483; G06F 9/445; G06F 3/0485; G06F 3/0482

(57) ABSTRACT

Various embodiments of the present disclosure relate to an electronic device and an information providing method. The electronic device includes a memory, a display unit, and a processor. The processor implements the method, including detecting at least one of an action associated with an application executed on the electronic device, and a subject indicated by content associated with the executed application, curating at least one of a related information and a related function associated with the detected at least one of the action and the subject, generating for display an action page including the curated at least one of the related information the related function and storing the generated action page in the memory, and controlling the display unit to display the generated action page in response to detecting a designated input signal.

### CLAIM OF PRIORITY

This application claims the priority under 35 U.S.C. §119(a) to Korean Application Serial No. 10-2016-0083622, which was filed in the Korean Intellectual Property Office on Jul. 1, 2016, the entire content of which is hereby incorporated by reference.

### TECHNICAL FIELD

Various embodiments of the present disclosure relate to an electronic device that may curate related information based on an action or task executed within an electronic device to display the same to a user, and an information providing method thereof.

### BACKGROUND

Electronic devices such as a mobile terminals may provide various functions. For example, in addition to a basic voice communication functions, mobile terminals may provide an Internet access function, a music or video reproduction function, a photographic function, a navigation function, a messenger function, and other such functions. To these ends, the mobile terminals may include various applications. For example, the mobile terminals may include a browser application for Internet access, a multimedia application for music or video reproduction, a camera application for taking a photo or a video, and a navigation application for guiding directions, and a messenger application for a messenger service.

### SUMMARY

Due to limitations in the size of a screen, these electronic devices may present inconvenience when switching a current application to another application, especially when a user intends to utilize another application. For example, when a user executes a search for a trip location, while simultaneously discussing the location with a friend using a messenger application, an inconvenience presents in that the user must exit from the messenger application and execute a browser application to search for the trip location.

Meanwhile, the applications may include various functions. The various functions may have a hierarchical structure in general. Accordingly, a user may encounter inconvenience in being required to go through a large number of steps in order to execute a menu disposed within a lower layer of the hierarchical structure. For example, when a user attempts to add a schedule, the user may go through the steps of executing a particular scheduler application, selecting a schedule management menu, selecting a schedule add menu, and finally entering a schedule.

Various embodiments of the present disclosure may curate and store related information and/or related functions based on actions occurring in an electronic device, and may provide the curated related information and/or related functions when a designated (preset) input is detected.

According to various embodiments of the present disclosure, an electronic device is disclosed, including a memory, a display unit, and a processor operable coupled with the memory and the display unit, the processor configured to: detect at least one of an action associated with an application executed on the electronic device, and a subject indicated by content associated with the executed application; curate at least one of a related information and a related function associated with the detected at least one of the action and the subject, generate an action page including the curated at least one of the related information and the related function and store the generated action page in the memory, and control the display unit to display the generated action page in response detecting a designated input signal.

According to various embodiments of the present disclosure, an information providing method of an electronic device is disclosed, including detecting, by a processor, at least one of an action associated with an application executed on the electronic device, and a subject indicated by content associated with the executed application, curating at least one of a related information and a related function associated with the detected at least one of the action and the subject, generating an action page including the curated at least one of the related information the related function and storing the generated action page in a memory, and controlling a display unit to display the generated action page in response to detecting a designated input signal.

### BRIEF DESCRIPTION OF THE DRAWINGS

The above and other aspects and features of the present disclosure will be more apparent from the following detailed description taken in conjunction with the accompanying drawings, in which:

FIG. 1 is a block diagram illustrating a configuration of an electronic device according to an embodiment of the present disclosure;

FIG. 2 is a diagram for conceptually describing an action page according to an embodiment of the present disclosure;

FIG. 3 is a flowchart for describing an information providing method of an electronic device according to an embodiment of the present disclosure;

FIG. 4 is a flowchart for describing a method for generating an action page by curating related information and a related function;

FIG. 5 is a diagram for describing an example of configuring an action page according to an embodiment of the present disclosure;

FIG. 6A and FIG. 6B are diagrams for describing examples of configuring an action page according to an embodiment of the present disclosure;

FIG. 7 is a diagram for describing an interaction of an action page according to an embodiment of the present disclosure; and

FIG. 8A and FIG. 8B are diagrams illustrating an action page according to an embodiment of the present disclosure.

### DETAILED DESCRIPTION

Embodiments of the present disclosure are described in detail with reference to the accompanying drawings. The same or similar components may be designated by the same or similar reference numerals although they are illustrated in different drawings. Detailed descriptions of implementations or processes known in the art may be omitted to avoid obscuring the subject matter of the present disclosure.

The terms used herein are defined in consideration of functions of the present disclosure and may vary depending on a user's or an operator's intention and usage. Therefore, the terms used herein should be understood based on the descriptions made herein. It is to be understood that the singular forms “a,” “an,” and “the” include plural referents unless the context clearly dictates otherwise. In the present disclosure, an expression such as “A or B,” “at least one of A and B,” or “one or more of A and B” may include all possible combinations of the listed items. Expressions such as “first,” “second,” “primarily,” or “secondary,” as used herein, may represent various elements regardless of order and/or importance, and do not limit corresponding elements. The expressions may be used for distinguishing one element from another element. When it is described that an element (such as a first element) is operatively or communicatively “coupled to” or “connected to” another element (such as a second element), the element can be directly connected to the other element or can be connected through another element (such as a third element).

The expression “configured to (or set)”, as used in the present disclosure, may be used interchangeably with, for example, “suitable for,” “having the capacity to,” “designed to,” “adapted to,” “made to,” or “capable of” according to the situation. The term “configured to (or set)” does not only mean “specifically designed to” by hardware. Alternatively, in some situations, the expression “apparatus configured to” may mean that the apparatus “can” operate together with another apparatus or component. For example, the phrase “a processor configured (or set) to perform A, B, and C” may be a generic-purpose processor (such as a central processing (CPU) or an application processor (AP)) that can perform a corresponding operation by executing at least one software program stored at an exclusive processor (such as an embedded processor) for performing a corresponding operation or at a memory device.

An electronic device, according to embodiments of the present disclosure, may be embodied as, for example, at least one of a smart phone, a tablet PC, a mobile phone, a video phone, an e-book reader, a desktop PC, a laptop PC, a notebook computer, a workstation, a server, a PDA, a portable multimedia player (PMP), an MPEG 3 (MP3) player, medical equipment, a camera, and a wearable device. The wearable device can include at least one of an accessory type (e.g., a watch, a ring, a bracelet, an ankle bracelet, a necklace, glasses, a contact lens, or a head-mounted-device (HMD)), a fabric or clothing embedded type (e.g., electronic garments), a body attachable type (e.g., a skin pad or a tattoo), and an implantable circuit. The electronic device may be embodied as at least one of, for example, a television, a digital versatile disc (DVD) player, an audio device, a refrigerator, an air-conditioner, a cleaner, an oven, a microwave oven, a washing machine, an air cleaner, a set-top box, a home automation control panel, a security control panel, a media box, an electronic dictionary, an electronic key, a camcorder, and an electronic frame.

In another embodiment, the electronic device may be embodied as at least one of various medical devices (such as, various portable medical measuring devices (a blood sugar measuring device, a heartbeat measuring device, a blood pressure measuring device, or a body temperature measuring device), a magnetic resonance angiography (MRA) device, a magnetic resonance imaging (MRI) device, a computed tomography (CT) device, a scanning machine, and an ultrasonic wave device), a navigation device, a global navigation satellite system (GNSS), an event data recorder (EDR), a flight data recorder (FDR), a vehicle infotainment device, electronic equipment for ship (such as, a navigation device for ship and gyro compass), avionics, a security device, a head unit for a vehicle, an industrial or home robot, a drone, an automated teller machine (ATM) of a financial institution, a point of sales (POS) device of a store, and an Internet of things (IoT) device (e.g., a light bulb, various sensors, a sprinkler device, a fire alarm, a thermostat, a street light, a toaster, sports equipment, a hot water tank, a heater, and a boiler).

According to an embodiment, the electronic device may be embodied as at least one of a portion of furniture, building/construction or vehicle, an electronic board, an electronic signature receiving device, a projector, and various measuring devices (e.g., water supply, electricity, gas, or electric wave measuring device). An electronic device, according to an embodiment, can be a flexible electronic device or a combination of two or more of the foregoing various devices. An electronic device is not limited to the foregoing devices may be embodied as a newly developed electronic device. The term “user”, as used herein, can refer to a person using an electronic device or a device using an electronic device (e.g., an artificial intelligence electronic device).

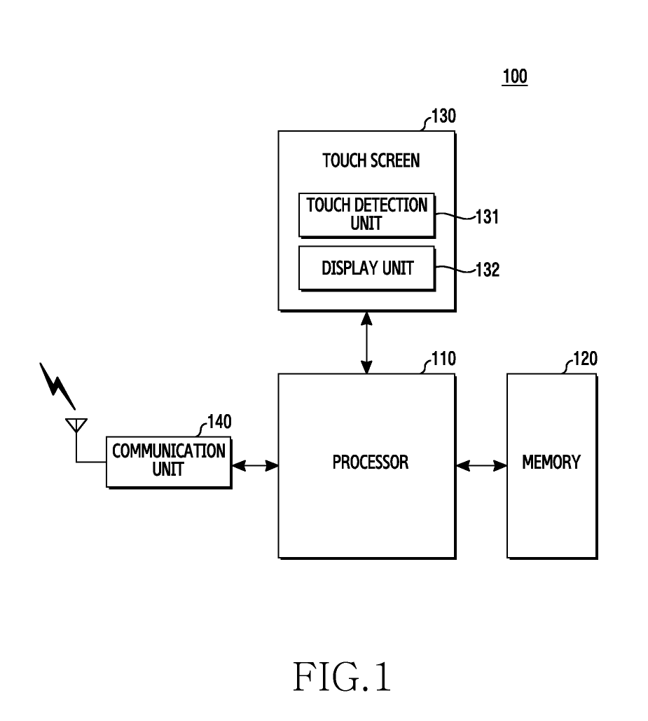

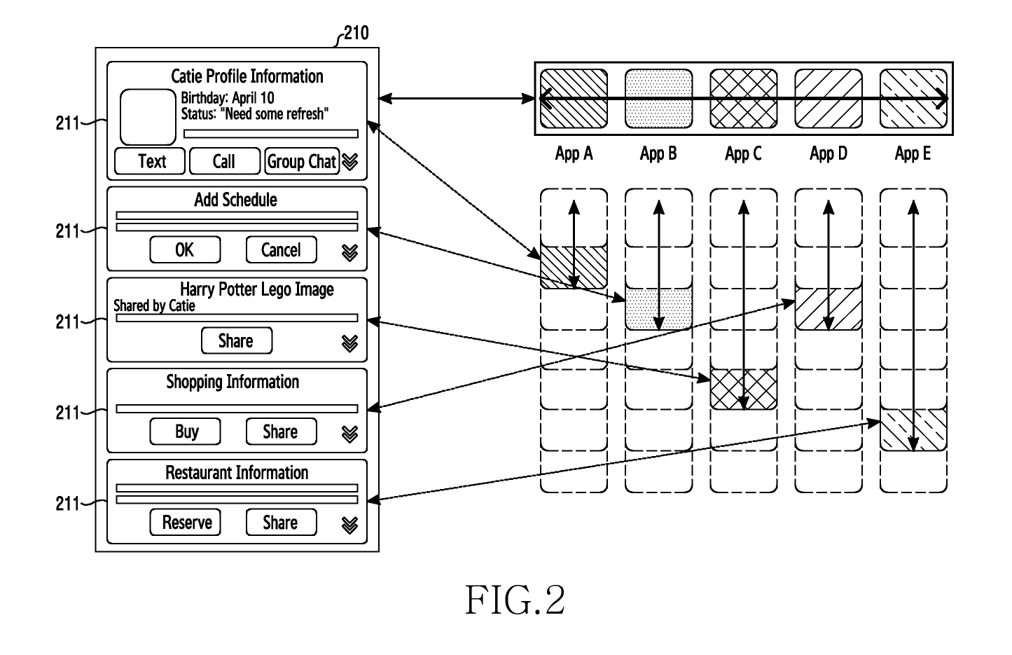

FIG. 1 is a block diagram illustrating a configuration of an electronic device according to an embodiment of the present disclosure, and FIG. 2 is a diagram for conceptually describing an action page according to an embodiment of the present disclosure.

Referring to FIG. 1 and FIG. 2, an electronic device 100 according to an embodiment of the present disclosure may include a processor 110, a memory 120, a touch screen 130, and a communication unit 140.

The processor 110 may control overall operations of the electronic device 100. Further, the processor 110 may control elements of the electronic device 100. For example, the processor 110 may receive instructions from the memory 120, and control each of the elements according to the received instructions, so as to perform various functions.

The processor 110 may include a central processing unit (CPU), an application processor (AP), a micro control unit (MCU), and the like. The processor (e.g., a controller) 110 may include a single core processor or a multi-core processor. Alternatively, the processor 110 may be a multiprocessor including multiple processors. For example, the processor 110 may include an application processor (AP) and a communication processor (CP).

According to various embodiments, the processor 110 may control operations of curating and providing related information and/or a related function, based on an action (task) and/or a subject (keyword) that are generated by the electronic device 100. For example, the processor 110 may recognize an action and/or a subject that are generated by the electronic device 100, and curate related information and a related function, which are associated with at least one of the recognized action and the recognized subject. For example, the processor 110 may curate the related information and the related function throughout the electronic device 100. The curated related information and the curated related function may be information and a function that can be directly identified or executed.

The processor 110 may output, through the display unit 132, the curated related information and the curated related function in response to a designated (preset) input (e.g., specific key or combination of keys, tap, double tap, long touch, gesture, multi-touch, pressure touch, etc.). At this time, the processor 110 may display the curated related information and the curated related function for each application. For example, the processor 110 may search for related information and a related function, that can be identified or executed through at least one operation, from each of a plurality of applications App A, App B, App C, App D, and App E, as illustrated in FIG. 2. The processor 110 may generate action cards 211 including the related information and the related function, which have been searched for by each application, and arrange the generated action cards in a form configured according to a configured condition (e.g., degree of association, frequency of use, recent use, etc.), so as to generate an action page 210.

The processor 110 may store the action page 210 in the memory 120. The processor 110 may update the action cards 211 and the action page 210 in real time. Thus, various embodiments of the present disclosure may provide various related information and related functions, which are distributed in a plurality of applications, through one action page. Accordingly, a user may directly identify or execute the related information or the related function without switching to another application. In other words, the user may be able to have a horizontal access to the related information or the related functions, which are stored in the electronic device 100, instead of a vertical access.

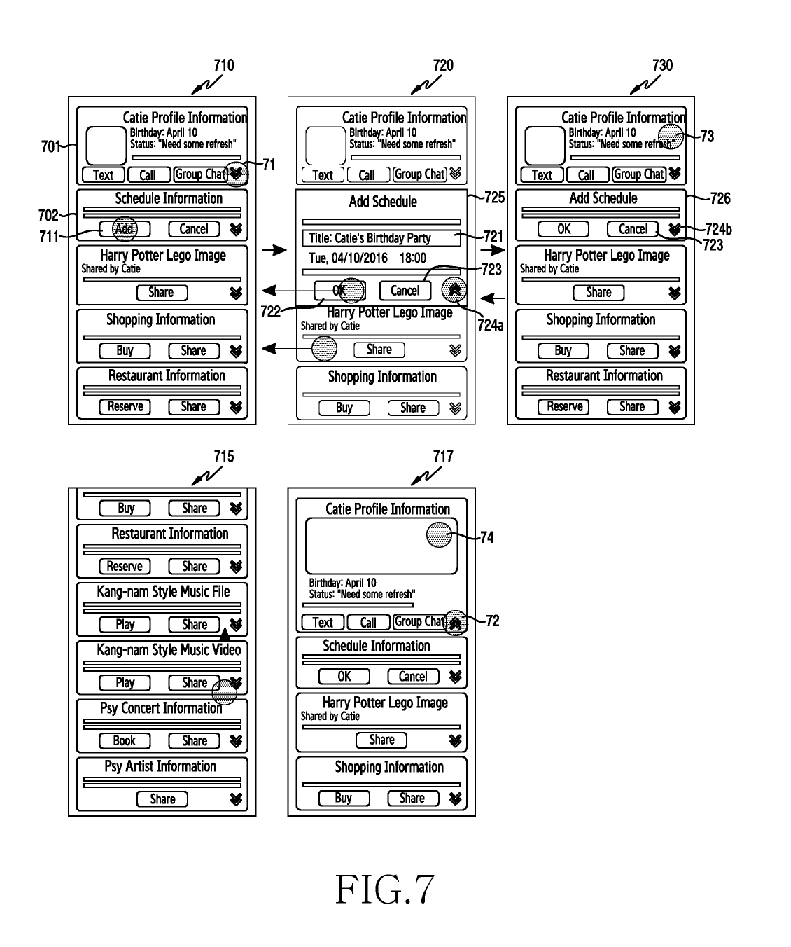

The processor 110 may execute a function corresponding to an input detected on the action page. For example, the processor 110 may display selected related information in detail, or execute a selected related function. A detailed description thereof will be described later with reference to FIG. 7.

The memory 120 may store various programs for operating the electronic device 100, and store data generated in the middle of performing the various programs, downloaded data, or the like. Further, the memory 120 may store various commands and/or instructions for operating the processor 110. The memory 120 may include at least one of an embedded memory and an external memory. The embedded memory may include at least one of a volatile memory (e.g., dynamic random-access memory (DRAM), static random-access memory (SRAM), SDRAM, or the like), a non-volatile memory (e.g., one time programmable read only memory (OTPROM)), a PROM, an erasable PROM (EPROM), an electrically EPROM (EEPROM), a mask ROM, a flash ROM, a flash memory, a hard drive, and a solid state drive (SSD). The external memory may include at least one of a flash drive, a compact flash (CF), a secure digital (SD), a micro-SD, a mini-SD, an extreme digital (xD), a multi-media card (MMC), and a memory stick.

According to various embodiments, the memory 120 may store programs for controlling a procedure of curating and providing related information and a related function based on an action and a subject in the electronic device 100. The programs may include: a routine of recognizing at least one of an action and/or a subject, that are in progress, by analyzing an application or a content; a routine of curating related information and/or a related function, which are associated with the action and/or the subject; a routine of generating an action page based on the curated related information and/or the curated related function; and a routine of updating the action page.

The touch screen 130 may provide an input function and an output function. To this end, the touch screen 130 may include a touch detection unit 131 and the display unit 132. The touch detection unit 131 may provide an input function. For example, the touch detection unit 131 may detect (or recognize) various touch inputs (e.g., tap, double tap, touch, touch movement, multi-touch, pressure touch, etc.) using a finger, a stylus, an electronic pen, etc., and transfer the same to the processor 110.

The display unit 132 may provide an output function. The display unit 132 may include, for example, a liquid crystal display (LCD), a light emitting diode (LED) display, an organic light emitting diode (OLED) display, a micro electro mechanical system (MEMS) display, or an electronic paper display. The display unit 132 may be flexible, transparent, or wearable. Alternatively, the display unit 132 may include a projector that can display an image by projecting light onto a screen located inside or outside of the electronic device 100 and/or a hologram device that can show a stereoscopic image in the air using light interference.

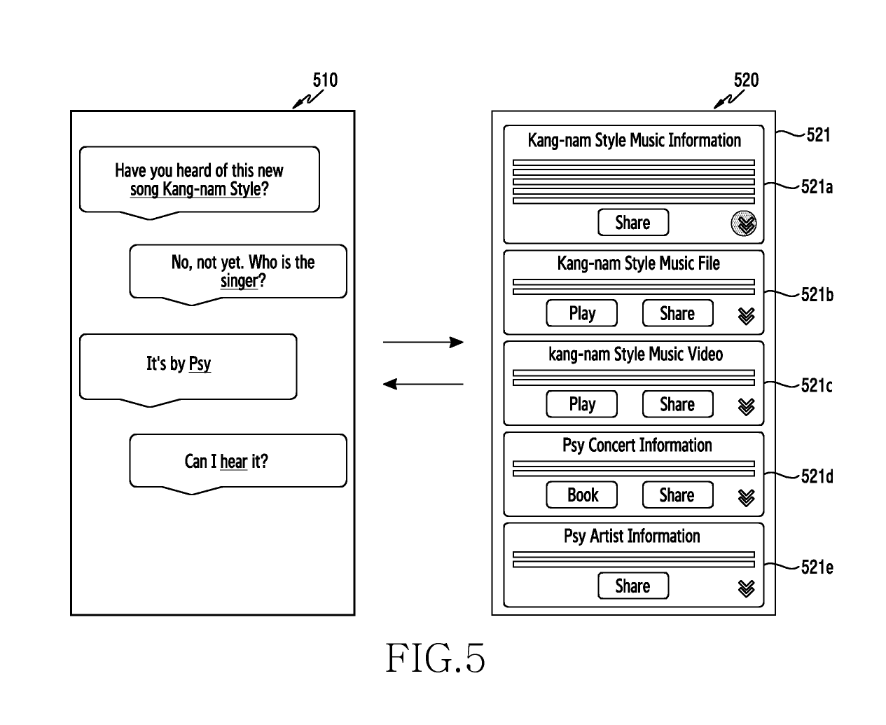

The display unit 132 may display, for example, various contents (e.g., text, image, video, icon, and/or symbol). The display unit 132 according to various embodiments may display various screens as illustrated in FIG. 5 to FIG. 8B, that will be described later.

The communication unit 140 may perform a communication function. The communication unit 140 may perform communication by wire or wirelessly. The communication unit 140 may include a USB communication module, a Wi-Fi communication module, a Bluetooth (BT) communication module, a near field communication (NFC) communication module, a global positioning system (GPS) module, and the like. According to an embodiment, at least some (e.g., two or more) of the Wi-Fi communication module, the BT communication module, the NFC module, and the GPS module may be included in one integrated chip (IC) or an IC package.

According to various embodiments, the communication unit 140 may transmit an action and a subject that are generated by the electronic device 100 to another electronic device (e.g., a wearable device, a tablet PC, a smart TV, a web server, a cloud server, etc.), and receive related information and a related function that can be identified or executed through the another electronic device. Alternatively, the communication unit 140 may receive an action and a subject from another electronic device, and curate related information and/or a related function, so as to transmit the same to the another electronic device, under a control of the processor 110.

Meanwhile, although not illustrated in FIG. 1, the electronic device 100 may not include some of described elements. Alternatively, the electronic device 100 may further include various elements (e.g., a sensor module, an audio processing unit, a camera, a microphone, etc.) at an equivalent level to the described elements.

According to various embodiments of the present disclosure, an electronic device may include: a memory; a display unit; and a processor functionally connected with the memory and the display unit, wherein the processor is configured to perform control to: recognize at least one of an action and a subject, that are in progress, based on an action occurring in the electronic device; curate at least one of related information and a related function, which are associated with at least one of the recognized action and the recognized subject, among information and functions that are stored in the electronic device; generate an action page which enables direct identification and execution of the curated related information and the curated related function, and store the action page in the memory; and output the stored action page to the display unit in response to detection of a designated input signal.

According to various embodiments, the processor may be configured to: curate the related information and the related function for each application; generate an action card corresponding to each application based on the related information and the related function, for which curation is performed for each application; and generate the action page by arranging the generated action cards with reference to relevancy and recent use.

According to various embodiments, the processor may be configured to select related information and a related function, that are to be included in the action card, in consideration of at least one of relevancy to the recognized action and the recognized subject, a most recently used date, and a frequency of use, among the curated related information and the curated related functions.

According to various embodiments, the processor may be configured to update the action page in real time in the background.

According to various embodiments, the action page may be configured to be scrollable, and comprise a configured number of action cards or fewer, or an action card generated during a configured period.

According to various embodiments, the action card may be configured to comprise at least one among summary information, at least one function button, a thumbnail image, a recommendation action button, a related action button, a related content, and a size enlargement or reduction button, according to an attribute of an application.

According to various embodiments, the action card may be configured to be scrollable in at least one direction of up or down and right or left.

According to various embodiments, the related information or the related function may correspond to information or a function, that is directly identifiable or executable when selected.

According to various embodiments, the processor may be configured to perform control to remove the action page and return to a previous screen, when the designated input signal is input in a state where the action page has been displayed.

According to various embodiments, the processor may be configured to recognize at least one of the action and the subject, that are in progress, based on a plurality of actions occurring during a predetermined period or within a predetermined number of times.

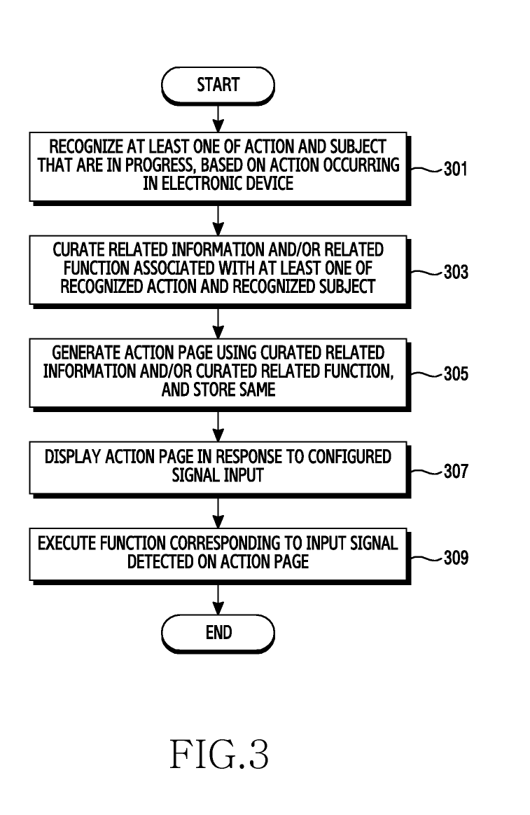

FIG. 3 is a flowchart for describing an information providing method of an electronic device according to an embodiment of the present disclosure.

Referring to FIG. 3, according to various embodiments of the present disclosure, in operation 301, the electronic device (e.g., the processor 110 of the electronic device 100) may recognize at least one of an action and a subject that are in progress (e.g., presently being executed), based on an action occurring in the electronic device.

In operation 303, the electronic device may curate (e.g., collect and select) related information and/or a related function, which are associated with at least one of the recognized action and the recognized subject.

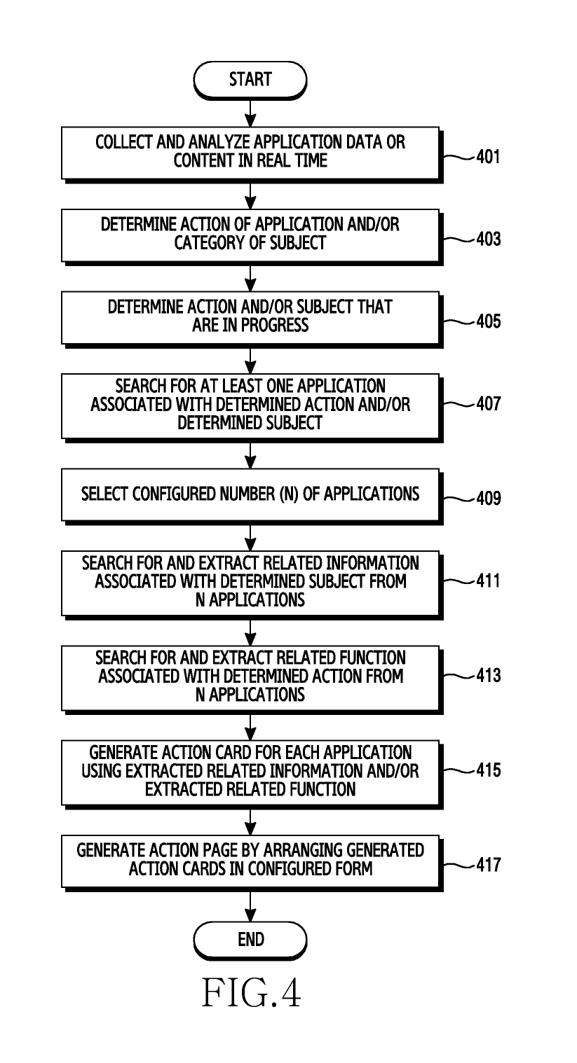

In operation 305, the electronic device may generate and store an action page using the curated related information and/or the curated related function. In various embodiments, operations 301 to 305 of generating the action page may be performed in the background in real time. A detailed description thereof will be made with reference to FIG. 4.

In operation 307, the electronic device may output the generated action page to the screen in response to a configured (or pre-designated) signal input. The electronic device may output the action page regardless of a current screen state (e.g., home screen, lock screen, application execution screen, etc.) when the input signal is detected.

In operation 309, the electronic device may perform a function corresponding to an input detected on the action page. For example, the electronic device may perform various functions (e.g., enlargement/reduction of an action card, scrolling, execution of an application corresponding to an action card, execution of a related function, etc.) as illustrated in FIG. 7. A detailed description thereof will be described later with reference to FIG. 7.

Meanwhile, although not illustrated, the electronic device may terminate display of the action page and return to a previous screen when the configured signal is input in a state where the action page has been displayed. At this time, the electronic device may perform operation 301 to operation 305 in the background so as to update the action page in real time.

FIG. 4 is a flowchart for describing a method for generating an action page by curating related information and a related function.

Referring to FIG. 4, according to various embodiments of the present disclosure, in operation 401, the electronic device (e.g., the processor 110 of the electronic device 100) may collect and analyze accessed application data, accessed content, and/or generated content in real time in order to recognize (e.g., detect) an action and/or a subject that are in progress. For example, the electronic device may analyze (e.g., detect) a type/category of an application, an executed function, a displayed or generated content, an accessed time and/or location, and the like. The electronic device may analyze a retrieved, input, transceived, or viewed keyword, text or a content.

In operation 403, the electronic device may determine an action of an application and/or a subject of a category based on a result of the analysis. In operation 405, the electronic device may determine an action and/or a subject that are being executed or otherwise in progress. For example, the electronic device may determine an action and/or a subject with reference to [TABLE 1] below.

TABLE 1

| application | action/task | subject/keyword |
|---|---|---|
| call, message, SNS, contact information, | communication, | X |
| email, etc. | sharing | |
| browser, finder, map, navigation | search | map, navigation |
| music, video, image, streaming, gallery, | reproduction, view | music, video, image |
| player | | |
| camera, recorder, editor | creation, edit | X |
| memo, note, recorder | record, storage | X |
| widget (location, weather, news, etc.) | update | location, weather |
| calendar, event, reminder, schedule, | plan, management | health |
| planner, alarm, health | | |
| restaurant, hotel, flight, vehicle, hospital, | reservation, | restaurant, hotel, flight, vehicle, |
| rate | payment | hospital, rate |
| shopping, show/movie | purchase, order | shopping, show/movie |
| ticket/transportation, freight | | ticket/transportation, freight |
| expenses, banking | financial | expenses, banking |
| | management | |
| phone, connection device, configuration, | device | connectivity |
| device management, connectivity | management | |
| my file, cloud | data management | cloud |

Referring to [TABLE 1], when an application, such as call application, message application, or text application such as SNS is being executed, the electronic device may determine “communication” and/or “sharing” as an action. Alternatively, when an application, such as music player, video player, and/or image viewer is being executed, the electronic device may determine “reproduction” as an action and, in some cases, determine “music” as a subject. It is understood that the embodiment [TABLE 1] is merely an example, and is not intended to limit embodiments of the present disclosure to [TABLE 1].

In operation 407, the electronic device may search for at least one other application associated with the determined action and/or the determined subject. In operation 409, the electronic device may select a predetermined number (e.g., N (herein, N=“natural number”)) of applications or fewer application than the predetermined number. The electronic device may select N or fewer applications in consideration of (e.g., based on) relevancy, recent use, a frequency of use, and the like.

In operation 411, the electronic device may search for and extract related information from the N or fewer applications, based on the determined subject. At this time, the electronic device may select and extract as main information some portion or pieces of the retrieved related information based on relevancy to the subject, recent use, a frequency of use, etc. In order to search for and extract the related information, the electronic device may activate (e.g., execute) the selected N or fewer applications in the background.

In operation 413, the electronic device may search for related functions from the N or fewer applications based on the determined action, and extract the same. At this time, the electronic device may select and extract, as a main related function, some of the retrieved related functions based on relevancy to the determined action, recent use, a frequency of use, etc. The main related function may be selected and extracted as many times as the configured number thereof. Again, in order to search for and extract the related function, the electronic device may activate the selected N or fewer applications in the background.

In operation 415, the electronic device may generate an action card for each application using the extracted related information and/or the extracted related function. The extracted main related information and the extracted main related function may be arranged in a predefined appearance (e.g., a preset format or layout) on a corresponding action card.

In operation 417, the electronic device may generate an action page by arranging the generated action cards in the predefined or preconfigured appearance (e.g., they may be disposed in a list, or along a line). For example, the electronic device may generate the action page by arranging, in the upper side, an action card which is highly relevant to the recognized action and the recognized subject and has been recently used. The generated action may be stored in a memory (e.g., the memory 120 in FIG. 1). The electronic device may perform operation 401 to operation 417 in the background. Further, the electronic device may update the action card and the action page in real time.

FIG. 5 is a diagram for describing an example of configuring an action page according to an embodiment of the present disclosure.

Referring to FIG. 5, an electronic device (e.g., the processor 110 of the electronic device 100) according to an embodiment of the present disclosure may be presently executing a messenger application. For example, a user may be chatting with another user “Anne” regarding a recent popular song. At this time, the electronic device may analyze the chat messages transmitted or received within a predetermined time period regardless of whether the messages are displayed on the screen or not, and use this analysis to detect an action and a subject indicated within the messages. To this end, the electronic device may extract a subject from the chatting messages using a known natural language analysis technique, etc. For example, the electronic device may extract information such as a subject, a date, a proper noun (e.g., a name, location name, a region name, etc.), a word matching the name of a file or an application stored in the electronic device, a word associated with a user's action, a word designated by a user, and the like. For example, the electronic device may extract as a subject, “song Gangnam style”, “singer”, “Psy”, and “hear” from chatting messages, as shown in the element 510 of FIG. 5.

The electronic device may curate a related function and/or related information from an application or contents stored in the electronic device, based on the extracted subject. For example, the electronic device may search for the subject using a browser. Further, the electronic device may search for a related content among contents (e.g., photo, music file, video, document, etc.) stored in the memory 120. Further, the electronic device may search for a video associated with the subject using a video search app (e.g., YouTube). Further, the electronic device may search for concert information associated with the subject using a ticket booking app.

The curated function or information may be output in response to a user's request. For example, the electronic device may display an action page 521, as illustrated in element 520 of FIG. 5 when a predefined input (e.g., tap/sweep/double tap/pressure touch/multi-touch/gesture etc.) is detected in a messenger chatting screen. The action page 521 may include a plurality of action cards. For example, the action page 521 may include: a first action card 521a that displays “music information of Gangnam style” searched for through a browser; a second action card 521b that displays a music file stored in the electronic device; a third action card 521c that displays “music video information of Gangnam style” searched for through a video search app; a fourth action card 521d that displays “Psy concert information” searched for through a ticket booking application; and a fifth action card 521e that displays “personal information of Psy” searched for through a browser.

In the state as shown in the element 520, the electronic device may return to the state shown in the element 510 when the predefined input is detected.

Thus, various embodiments of the present disclosure may display an action page through a predefined input while using a chatting messenger, and directly identify and execute various information and functions associated with chatting messages through the action page without switching to a corresponding application screen. Meanwhile, FIG. 5 is merely an example, and does not limit embodiments of the present disclosure.

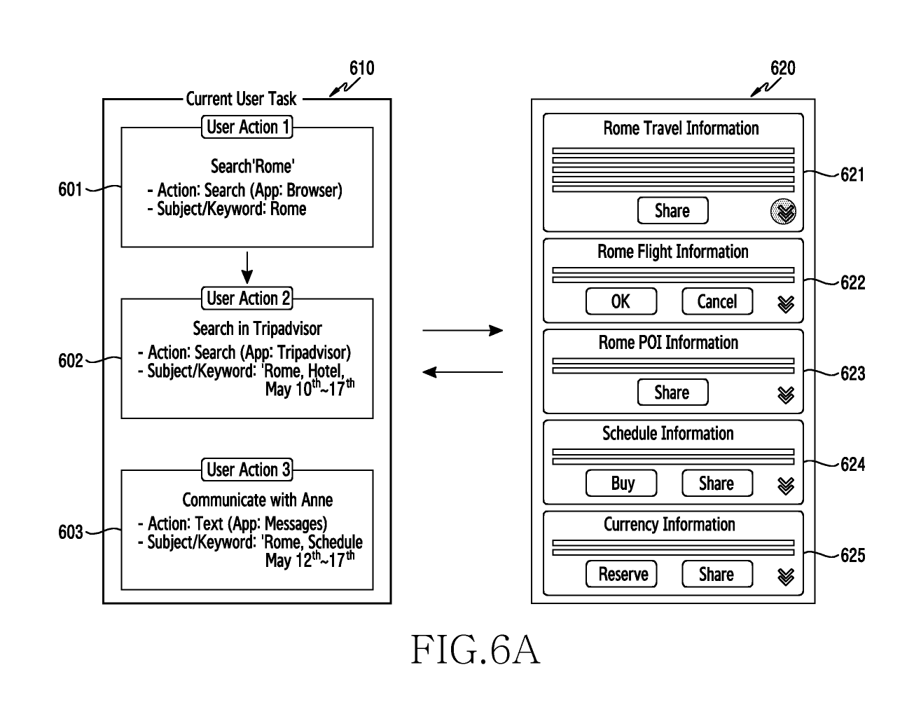

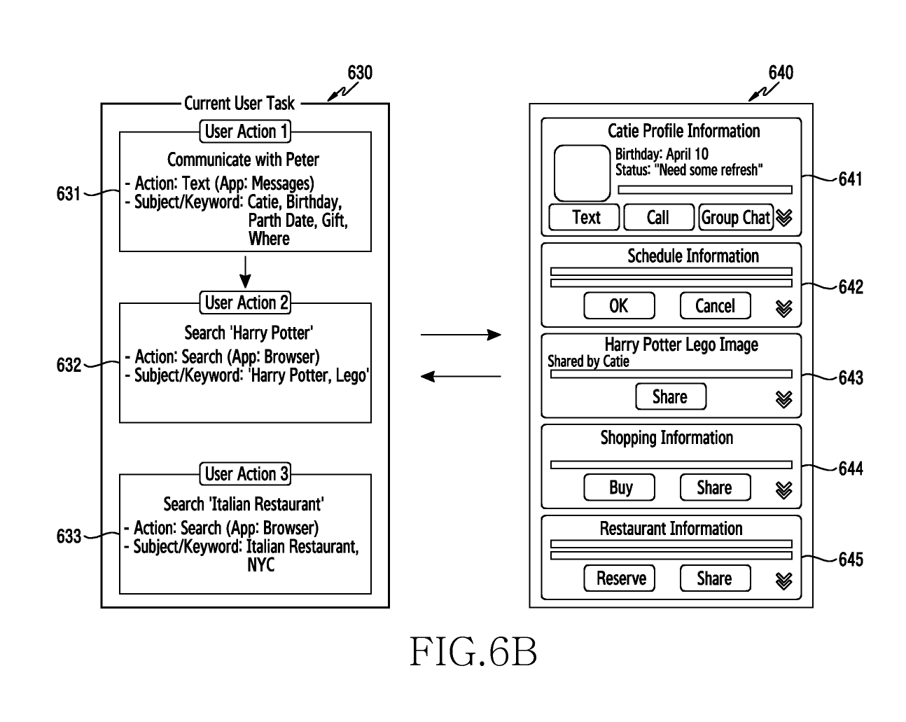

FIG. 6A and FIG. 6B are diagrams for describing examples of configuring an action page according to an embodiment of the present disclosure.

Referring to FIG. 6A, an electronic device according to an embodiment of the present disclosure may detect a plurality of user actions as shown in element 610. For example, a user may be planning a trip to Rome. In order to plan the trip to Rome, the user may search for “Rome (Roma)” using an app browser, as shown in element 601. In this case, the action may be “search”, and the subject may be “Rome”.

In addition, the user may search for a hotel available in Rome during the trip through a hotel app for procuring hotel accommodation information, as shown in element 602. In this case, the action may be “search”, and the subject may be “Rome, hotel, and May 12^{th}-17^{th}”.

Further, the user may exchange a message about an itinerary with “Anne”, as shown in element 603. In this case, the action may be “text”, and the subject may be “Rome, Schedule, May 12^{th}-17^{th}”.

After the occurrence of a series of actions described above, the electronic device may display the action page generated based on the actions and the subjects described above, as shown in element 620, when a designated input (e.g., tap, sweep, pressure touch, etc.) is detected.

The action page may include: an action card 621 that provides Rome travel information searched for through the Internet; an action card 622 that provides flight information to Rome; an action card 623 that provides information on tourist attractions in Rome, stored in the memory; an action card 624 that provides schedule information searched for using a date; and an action card 625 that provides exchange rate information searched for by a travel destination “Rome”. However, this is merely an example, and embodiments of the present disclosure are not limited to FIG. 6A.

Referring to FIG. 6B, the electronic device according to an embodiment of the present disclosure may detect a plurality of user actions, as shown in the drawing of element 630. For example, a user may be planning Catie's birthday party. To this end, the user may talk about Catie's birthday party with Peter using a messenger app, as shown in the drawing of element 631. In this case, the action may be “text”, and the subject may be “Catie, birthday, date, gift, where, and the like”.

In addition, the user may search for “Harry Potter” using a browser, as shown in element 632, in order to purchase a present. In this case, the action may be “search”, and the subject may be “Harry Potter, and Lego”.

Further, the user may search for “Italian restaurant” using a browser, as shown in element 633. In this case, the action is “search”, and the subject may be “Italian restaurant, and NYC”.

After the occurrence of a series of actions described above, the electronic device may display the action page generated based on the actions and the subjects described above, as shown in the drawing of element 640, when a designated input (e.g., tap, sweep, etc.) is detected.

The action page may include an action card 641 that provides profile information of Catie, an action card 642 that provides schedule information, an action card 643 that provides a Harry Potter Lego image, an action card 644 that provides shopping information, and an action card 645 that provides restaurant information. However, this is merely an example, and embodiments of the present disclosure are not limited to FIG. 6B.

As described above, various embodiments of the present disclosure may provide related information and a related function, which have high reliability and accuracy matching the intention of a user, as an action and/or a subject that are in progress are recognized based on a plurality of actions continuously occurring within a predetermined period (or a predetermined number of times).

FIG. 7 is a diagram for describing an interaction of an action page according to an embodiment of the present disclosure.

Referring to FIG. 7, the electronic device according to an embodiment of the present disclosure may display an action page as shown in element 710. At a later time, when an add button 711 is selected in an action card 702 which indicates the schedule information, the electronic device may display an add schedule window 725 on one side of the screen as shown in element 720. At this time, the electronic device may display the add schedule window 725 in a pop-up window form, and deactivate (e.g., blur) a part of the screen on which the add schedule window 725 is not displayed, as shown in element 720.

The add schedule window 725 may include a schedule input field 721, an OK button 722, a cancel button 723, and a reduce button 724a. A user may add a schedule through the schedule input field 721. The schedule having been added through the schedule input field 721 may be processed in the same way as that input through a schedule application. Accordingly, an embodiment of the present disclosure may directly execute a schedule addition function through an action page without execution of a schedule application.

When the OK button 722 is selected in the element 720, the electronic device may update schedule information, and return to the state shown in the element 710. At this time, the action card 702 which indicates the schedule information may display the updated schedule information.

Meanwhile, when the cancel button 723 is selected or when the external area of the add schedule window 725 is selected, the electronic device may return to the state shown in the element 710.

Meanwhile, in the element 720, when the reduce button 724a is selected, the electronic device may provide an action card 726 corresponding to the add schedule window 725 instead of the action card 702 which indicates the schedule information, as shown in the element 730. Referring to the element 730, it is noticeable that the reduce button 724a has been changed to an enlarge button 724b. In the element 730, when the cancel button 723 is selected, the electronic device may change the action card 726 for schedule addition to the action card 702 which indicates the schedule information, as shown in the element 710. On the other hand, when the enlarge button 724b is selected, the electronic device may display the add schedule window 725 as shown in the element 720.

Meanwhile, in the element 710, when an information display area 73 that provides profile information of Catie is selected, the electronic device may execute a contact information application that provides profile information.

In the element 710, when touch movement (e.g., dragging, flicking, etc.) is detected, the electronic device may scroll the screen as shown in the element 715.

In the element 710, when the enlarge button 71 is touched in an action card 701 that provides profile information of Catie, the electronic device may enlarge the size of the action card 701 that provides profile information of Catie, and display the profile information in more detail, as shown in the element 717.

In the element 717, when the reduce button 72 is selected, the electronic device may return to the state shown in the element 710. In addition, when an information display area 74 that provides profile information of Catie is selected, the electronic device may execute the contact application that provides profile information.

As described above, an action page according to an embodiment of the present disclosure may include a plurality of action cards. Each action card may display main related information, and include at least one button for executing a main related function. In addition, each action card may include an enlarge button or a reduce button, which enlarges or reduces the size thereof. The action page is scrollable. Each action card may operate or be updated individually. The action page may include a preconfigured number of action cards. For example, action cards included in the action page may be updated based on an action occurring in the electronic device, and the oldest action card may be deleted when the configured number of action cards or more are generated. Alternatively, the action page may include an action card generated during a predetermined period (e.g., a week). For example, the action card may be deleted when the predetermined period passes after the action card is generated.

Meanwhile, the drawings illustrated in FIG. 7 are merely an example, and do not limit embodiments of the present disclosure.

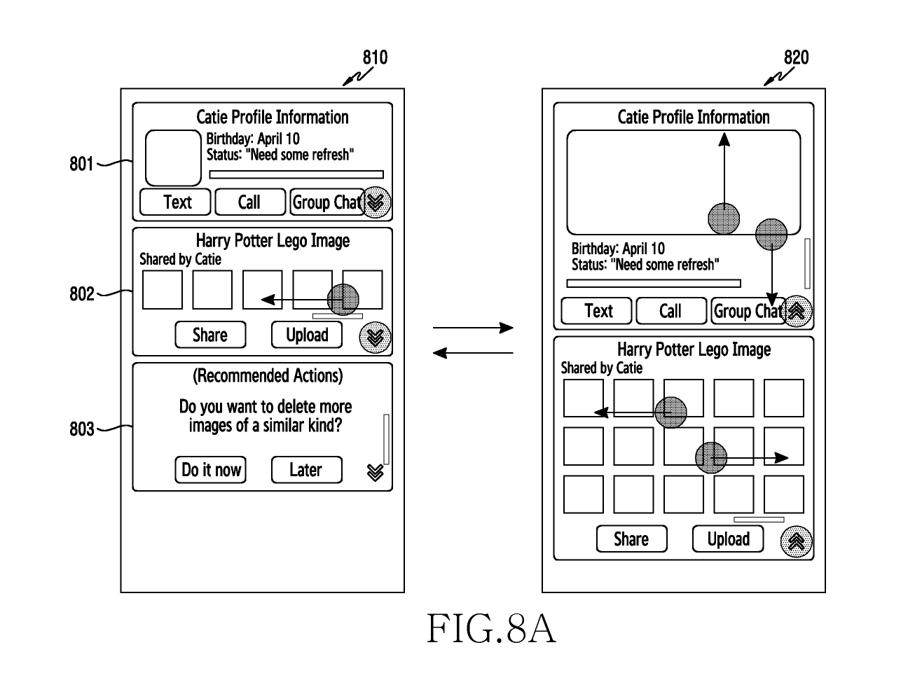

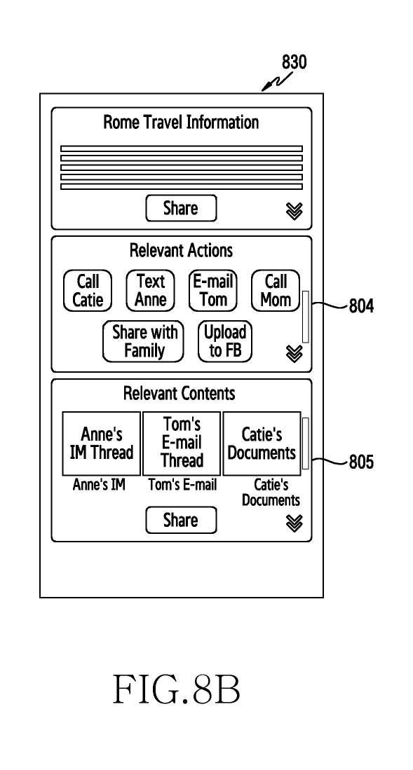

FIG. 8A and FIG. 8B are diagrams illustrating an action page according to an embodiment of the present disclosure.

Referring to FIG. 8A, an action card included in an action page according to an embodiment of the present disclosure may have various forms according to different functions (attributes or types). For example, as illustrated in an element 810, the action page may include: an action card 801 of a first form including summary information and a function button; an action card 802 of a second form that displays an image in a thumbnail form and includes a function button; or an action card 803 of a third form that provides a recommendation action. The action card may be scrolled up and down or right and left depending on the form thereof. For example, the action card 801 of the first form may not be scrolled, the action card 802 of the second form may not be scrolled right and left, and the action card 803 of the third form may be scrolled up and down.

Meanwhile, as illustrated in an element 820, the action card 801 of the first form may be scrolled up and down when the action card 801 is enlarged. According to an embodiment, the action card 802 of the second form may be scrolled right and left when the action card 802 is enlarged.

Referring to FIG. 8B, as illustrated in an element 830, an action page according to an embodiment of the present disclosure may include: an action card 804 that provides at least one related action associated with a related action or a related subject, which are associated with an action of the current user; and an action card 805 which provides at least one related content associated with the action or the subject, which is associated with the action (e.g., task) of the current user.

Meanwhile, in the element 810 in FIG. 8A, it is illustrated that action cards before enlargement have the same size, but the sizes of the action cards (e.g., a vertical length) may be different from each other. In addition, in the element 820, it is illustrated that the action cards are enlarged to the same size. However, said action cards may have different sizes upon enlargement.

According to various embodiments of the present disclosure, an information providing method of an electronic device, may include: recognizing at least one of an action and a subject, that are in progress, based on an action occurring in the electronic device; curating at least one of related information and a related function, which are associated with at least one of the recognized action and the recognized subject, among information and functions that are stored in the electronic device; generating an action page which enables direct identification and execution of the curated related information and the curated related function, and storing the action page in the memory; and outputting the stored action page to the display unit in response to detection of a designated input signal.

According to various embodiments, the curating of the at least one of the related information and the related function may include: curating the related information and the related function for each application, and generating of the action page comprises: generating an action card corresponding to each application based on the related information and the related function, for which curation is performed for each application; and generating the action page by arranging the generated action cards with reference to at least one of relevancy and the order of recent use.

According to various embodiments, the generating of the action card may include: selecting related information and a related function, that are to be included in the action card, in consideration of at least one of relevancy to the recognized action and the recognized subject, a most recently used date, and a frequency of use, among the curated related information and the curated related functions.

According to various embodiments, the method may further include: updating the action page in real time in the background.

According to various embodiments, the action page may be configured to be scrollable and comprise a configured number of action cards or fewer, or an action card generated during a configured period.

According to various embodiments, the generating of the action card may include: generating the action card in a form configured according to an attribute of an application.

According to various embodiments, the action card may be configured to be scrollable in at least one direction of up or down and right or left.

According to various embodiments, the method may further include: when the related information or the related function is selected on the action page, directly executing the corresponding information or the corresponding function.

According to various embodiments, the method may further include: removing the action page and returning to a previous screen, when the designated input signal is input in a state where the action page has been displayed.

According to various embodiments, the recognizing of the at least one of the action and the subject, that are in progress may include: recognizing at least one of the action and the subject, that are in progress, based on a plurality of actions occurring during a predetermined period or within a predetermined number of times.

Various embodiments of the present disclosure may analyze an action (task) and a subject (keyword) that are generated by an electronic device in real time, curate related information and/or a related function for each application and store the same, and provide the curated related information and/or the curated related function when a designated input is detected. A user may directly identify the related information or directly execute the related function, without switching to another application. Therefore, various embodiments of the present disclosure may improve the convenience of the user. In addition, various embodiments of the present disclosure may curate the related information and/or the related function in the background, and update the same in real time. Further, various embodiments of the present disclosure may provide the related information and the related function, which have high reliability and accuracy, through curating the related information and/or the related function based on a plurality of continuous actions.

The term “module”, as used herein, can imply a unit including hardware, software, and firmware, or any suitable combination. The term “module” can be interchangeably used with terms such as “unit”, “logic”, “logical block”, “component”, “circuit”, and the like. A module can be a minimum unit of an integral component or can be a part thereof. A module can be a minimum unit for performing one or more functions or may be a part thereof. A module can be mechanically or electrically implemented. For example, a module, according to an embodiment of the present disclosure, can include at least one of an Application-Specific Integrated Circuit (ASIC) chip, a Field-Programmable Gate Arrays (FPGAs), and a programmable-logic device, which are known or will be developed and which perform certain operations.

At least some parts of a device (e.g., modules or functions thereof) or a method (e.g., operations), based on embodiments of the present disclosure, can be implemented with an instruction stored in a non-transitory computer-readable storage medium as a program module. When the instruction is executed by a processor, the processor can perform a function corresponding to the instruction.

The non-transitory computer readable recording medium can include, for example, a hard disk, a floppy disc, a magnetic medium (e.g., a magnetic tape), an optical storage medium (e.g., a Compact Disc-ROM (CD-ROM) or a DVD, a magnetic-optic medium (e.g., a floptical disc)), and an internal memory. The instruction can include code created by a compiler or code executable by an interpreter.

According to various embodiments, in relation to a computer-readable storage medium which stores commands, the commands are configured to enable at least one processor to perform at least one operation when the commands are executed by the at least one processor, in which the at least one operation may include: recognizing at least one of an action and a subject, that are in progress, based on an action occurring in the electronic device; curating at least one of related information and a related function, which are associated with at least one of the recognized action and the recognized subject, among information and functions that are stored in the electronic device; generating an action page which enables direct identification and execution of the curated related information and the curated related function, and storing the action page in the memory; and outputting the generated action page to the display unit in response to detection of a designated input signal.

The module or program module can further include at least one or more components among the aforementioned components, or can omit some of them, or can further include additional other components. Operations performed by a module, program module, or other components of the various embodiments of the present disclosure can be executed in a sequential, parallel, repetitive, or heuristic manner. In addition, some of the operations can be executed in a different order or may be omitted, or other operations may be added.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein.

The processor may include a microprocessor or any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), a Graphical Processing Unit (GPU), a video card controller, etc.

In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”. In addition, an artisan understands and appreciates that a “processor” or “microprocessor” may be hardware in the claimed disclosure. Under the broadest reasonable interpretation, the appended claims are statutory subject matter in compliance with 35 U.S.C. §101.

The embodiments of the present disclosure disclosed herein and shown in the drawings are merely specific examples presented in order to easily describe technical details of the present disclosure and to help the understanding of the present disclosure, and are not intended to limit the scope of the present disclosure. Therefore, it should be construed that, in addition to the embodiments disclosed herein, all modifications and changes or modified and changed forms derived from the technical idea of the present disclosure fall within the scope of the present disclosure.

What is claimed is:

1. An electronic device comprising:
a memory;
a display unit; and
a processor operable coupled with the memory and the display unit, the processor configured to:
detect at least one of an action associated with an application executed on the electronic device, and a subject indicated by content associated with the executed application,
curate at least one of a related information and a related function associated with the detected at least one of the action and the subject,
generate an action page including the curated at least one of the related information and the related function and store the generated action page in the memory, and
control the display unit to display the generated action page in response to detecting a designated input signal.

2. The electronic device of claim 1, wherein the processor is configured to:
generate action cards for display within the action page, each action card corresponding to each of a plurality of applications indicated in the curated at least one of the related information and the related function; and
position the action cards within the generated action page according to at least one of relevancy and an order of recency of use.

3. The electronic device of claim 2, wherein the at least one of the related information and the related function are curated based on at least one of relevancy to the detected at least one of the action and the subject, a date of last use, and a frequency of use.

4. The electronic device of claim 1, wherein the processor is configured to update the action page in real time via background execution on the electronic device.

5. The electronic device of claim 1, wherein the action page is scrollable and further comprises at least one of up to a preconfigured number of action cards, or at least one action card generated during a preconfigured period of time.

6. The electronic device of claim 2, wherein each action card further includes at least one of summary information, a function button, a thumbnail image, a recommendation action button, a related action button, a related content, a size alteration button, according to an attribute of each of the plurality of applications.

7. The electronic device of claim 2, wherein the action card is further scrollable along at least one of a vertical axis and a horizontal axis.

8. The electronic device of claim 1, wherein the curated at least one of the related information and the related function is identifiable or executable in response to a selection.

9. The electronic device of claim 1, wherein the processor is configured to:
remove the action page from the display unit and restore a previous screen in response to redetecting the designated input signal when the action page is displayed.

10. The electronic device of claim 1, wherein the processor is configured to detect the at least one of the action and the subject based on a plurality of actions executed within the application executed on the electronic device, the plurality of actions executed within a predetermined period or a predetermined number of times.

11. An information providing method of an electronic device, comprising:
detecting, by a processor, at least one of an action associated with an application executed on the electronic device, and a subject indicated by content associated with the executed application;
curating at least one of a related information and a related function associated with the detected at least one of the action and the subject;
generating an action page including the curated at least one of the related information the related function and storing the generated action page in a memory; and
controlling a display unit to display the generated action page in response to detecting a designated input signal.

12. The method of claim 11, further comprising: generating action cards for display within the action page, each action card corresponding to each of a plurality of applications indicated in the curated at least one of the related information and the related function; and
position the action cards within the generated action page according to at least one of relevancy and an order of recency of use.

13. The method of claim 12, wherein the at least one of the related information and the related function are curated based on at least one of relevancy to the detected at least one of the action and the subject, a date of last use, and a frequency of use.

14. The method of claim 11, further comprising updating the action page in real time via background execution on the electronic device.

15. The method of claim 11, wherein the action page is scrollable and further comprises at least one of up to a preconfigured number of action cards, or at least one action card generated during a preconfigured period of time.

16. The method of claim 12, wherein each of the action cards is generated in a form configured according to an attribute of each corresponding application of the plurality of applications.

17. The method of claim 12, wherein the action card is further scrollable along at least one of a vertical axis and a horizontal axis.

18. The method of claim 11, wherein the curated at least one of the related information and the related function is identifiable or executable in response to a selection.

19. The method of claim 11, further comprising removing the action page from the display unit and restoring a previous screen in response to redetecting the designated input signal when the action page is displayed.

20. The method of claim 11, further comprising:
detecting the at least one of the action and the subject based on a plurality of actions executed within the application executed on the electronic device, wherein the plurality of actions is executed within a predetermined period or a predetermined number of times.
